(19) United States
(12) Patent Application Publication
(10) Pub. No.: US 2011/0160983 A1
(43) Pub. Date: Jun. 30, 2011

(54) METHOD FOR CORRECTING THE CYLINDER UNBALANCING IN AN INTERNAL COMBUSTION ENGINE

(75) Inventors: Tommaso De Fazio, Torino (IT); Michele Bastianelli, Camerano - Ancona (IT); Giovanni Rovatti, Chieri (TO) (IT)

(73) Assignee: GM GLOBAL TECHNOLOGY OPERATIONS LLC, Detroit, MI (US)

(21) Appl. No.: 13/061,327

(22) PCT Filed: Jul. 27, 2009
(86) PCT No.: PCT/EP09/00543

§ 371 Date: Feb. 28, 2011

(30) Foreign Application Priority Data
Aug. 28, 2008 (GB) 0815614.3

(51) Int. Cl. F02D 41/04

(52) U.S. Cl. 701/103

(57) ABSTRACT

A method is provided for correcting the cylinder unbalancing in an internal combustion engine. The method includes, but is not limited to the steps of acquiring the crankshaft or engine speed signal while a fuel injector is energized for a determined period of time in which all other fuel injectors are de-energized, generating a square wave signal by scanning said markings with the detector, the signal having a predetermined period, performing a first period-summing step so as to obtain first segments of the periods, performing a digital anti-aliasing filtering of the first segments, performing a segment-summing step so as to obtain second, larger segments, performing a band-pass filtering step on predetermined harmonic components thus obtaining intermediate values, creating filtered correction values representative of an ideal crankshaft wheel speed signal, correcting the intermediate values using the filtered correction values thus obtaining final values, performing a proportional and integral control, component by component, based on the final values, summing (34) all the harmonic components values thus obtaining a fuel quantity correction value; and correcting the cylinder unbalancing by controlling the fuel injectors according to the fuel quantity correction value.

### CROSS-REFERENCE TO RELATED APPLICATIONS

This application is a U.S. National-Stage entry under 35 U.S.C. §371 based on International Application No. PCT/EP2009/005432, filed Jul. 27, 2009, which was published under PCT Article 21(2) and which claims priority to British Application No. 0815614.3, filed Aug. 28, 2008, which are all hereby incorporated in their entirety by reference.

### TECHNICAL FIELD

The technical field relates to cylinder balancing control in internal combustion engines, particularly diesel common rail engines for motor vehicles. In addition, the technical field relates to a method for correcting cylinder unbalancing.

### BACKGROUND

In conventional internal combustion engine, the quantity of fuel actually injected into each cylinder and at each injection may be different from the nominal fuel quantity requested by the electronic control unit (ECU) and which is used to determine the energizing time of the injectors.

There are several factors which contribute to this difference, particularly the dispersion of the injectors characteristics, due to the production process spread, and the time-drift variations of the same characteristics, due to aging of the injection system. In fact, the current injector production processes are not accurate enough to produce injectors with tight tolerances; moreover, these tolerances become worse with aging during the injector life-time. As a result, for a given energization time and a given rail pressure, the quantity of fuel actually injected may be different from one injector to another.

This difference in fuel injected quantity results in a torque unbalancing cylinder-by-cylinder, causing some problems such as differences in pressure peak, differences in heat release and dynamic effects on a crankshaft wheel used in association with a sensor or pick up to detect the crankshaft rotation.

Known control systems for correcting cylinder unbalancing comprise the steps of detecting the unbalancing magnitude cylinder-by-cylinder and modifying the cylinder-by-cylinder fuel injected quantity by means of a closed loop control. Particularly, conventional control systems are based on a crankshaft wheel signal analysis.

In a reciprocating internal combustion engine, the gas-pressure torque in each cylinder is a periodic function, due to the characteristics of the thermodynamic cycle. Thus, in a 4-stroke engine the gas-pressure torque has a period of 720° CA (Crankshaft Angle). In other words, if ω is the crankshaft revolution frequency, in a 4-stroke engine the gas-pressure torque has a frequency 0.5ω.

The gas-pressure torque in a 4-stroke engine can be expressed by means of a Fourier series, including the frequency 0.5 ω as the fundamental frequency, and its harmonic frequencies (1.0 ω, 1.5ω, 2.0 ω, 2.5 ω, 3.0 ω, etc.).

The harmonic component whose frequency is 0.5ω is defined as the component of order 0.5. As already stated above, this component has a period of 720° CA and its frequency is the same as the camshaft revolution frequency. The harmonic component with frequency 1.0 ω is defined as the component of order 1 and has a period of 360° CA; its frequency equals the crankshaft revolution frequency. The harmonic component whose frequency is 1.5 ω is defined as the component of order 1.5 and has a period of 240° CA.

The harmonic component whose frequency is 2.0 ω is the component of order 2 and has a period of 180° CA; in a 4-cylinder engine this frequency is the same as the (stroke-by-stoke) injection frequency (one injection occurs every 180° CA); in a 4-cylinder engine, this frequency and its multiples (2.0 ω, 4.0 ω, 6.0 ω, etc.) are defined as the major harmonics or majors orders.

The harmonic component whose frequency is 3.0 ω is defined as the component of order 3 and has a period of 120° CA; in a 6-cylinder engine this frequency is the same as the (stroke-by-stroke) injection frequency (one injection occurs every 120° CA); in a 6-cylinder engine this frequency and its multiples (3.0 ω, 6.0 ω, 9.0 ω, etc.) are defined as the major harmonics or major orders.

Crankshaft wheels are mounted on the crankshaft; they are generally divided into a predetermined number of regions along the circumference, each region having a precise angular width, typically the same for all regions.

In typical embodiments the crankshaft wheel has along its circumference a predetermined number of teeth, or a predetermined number of magnets. The choice depends on the kind of sensor used to detect the crankshaft wheel signal. The sensor is mounted on the engine block. During the crankshaft rotation, the regions run in front of the sensor and the sensor is able to detect the time duration of each region.

A predetermined number of regions make up a segment; hence, each segment has a precise angular width.

There are several systematic errors which produce systematic dynamic components not deriving from the actual crankshaft dynamics. A typical example of systematic errors are the geometrical errors due to crankshaft wheel production tolerances or mounting tolerances. The systematic errors do not have a constant magnitude, but show a drift in magnitude during lifetime.

In order to get a very accurate crankshaft wheel signal, the effect of the systematic dynamic components not deriving from the actual crankshaft dynamics must be known.

As it will become apparent from the following description, the embodiments of present invention are essentially based on processing an engine speed signal, in order to obtain a fuel quantity correction value which can be used to control the quantity of fuel injected by each injector.

U.S. Pat. No. 6,250,144 B1 discloses a method for correcting tolerances in a transmitter wheel.

### BRIEF DESCRIPTION OF THE DRAWINGS

The present invention will hereinafter be described in conjunction with the following drawing figures, wherein like numerals denote like elements, and:

FIG. 1 is a schematic picture of an internal combustion engine and a block diagram of an ECU arranged to perform a method according to an embodiment of the invention;

FIGS. 2a and 2b are a block diagrams of operations performed according to the method;

FIG. 3 is a schematic representation of a crankshaft wheel signal;

FIG. 4 is a graph of the transfer function of a filter of the prior art;

FIG. 5 is a graph of the transfer function of a filter used in the method;

FIG. 6 shows two graphs relating to the evaluation filtering stage of FIG. 2a; and

FIG. 7 is a schematic representation of the T control calculation block of FIG. 2b.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

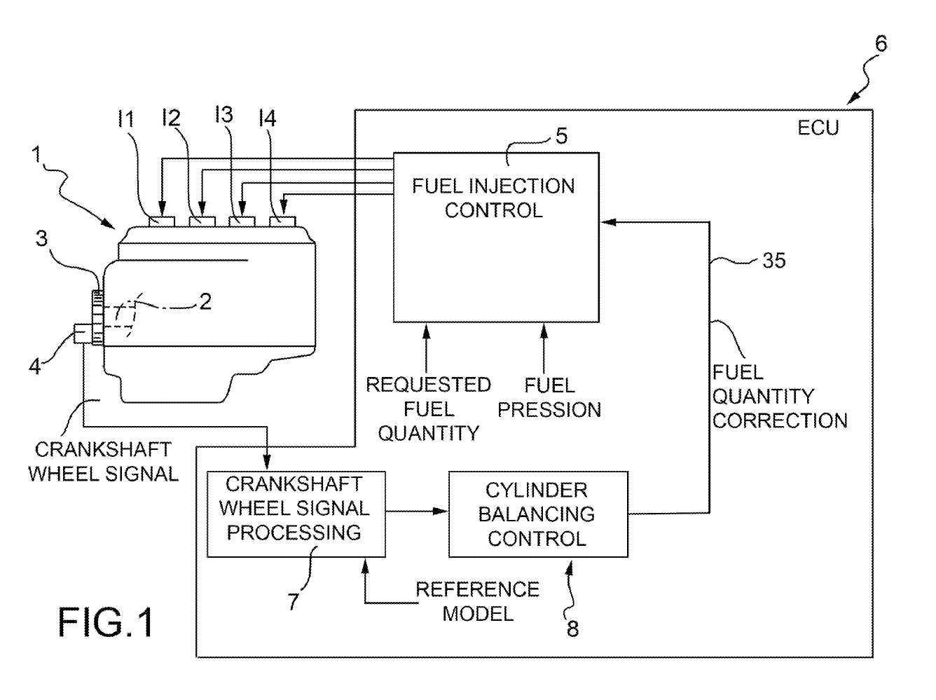

In FIG. 1 of the annexed drawings, reference number 1 indicates an internal combustion engine, particularly a diesel common rail engine, for use for instance in a motor vehicle.

The engine 1 is in particular a four-stroke engine, which in the exemplary embodiment shown has four cylinders, to which respective electrically-controlled fuel injectors I1-I4 are associated.

In a per se known manner the engine 1 comprises a crankshaft 2 to which a toothed wheel 3 is fixed. The wheel 3 has for example 60 angularly equispaced teeth having a same nominal angular width, and a pick-up device 4 is coupled thereto for providing a crankshaft or engine speed signal.

The fuel injectors I1-I4 are suitably driven by a fuel injection control module 5 of an ECU 6 of the engine 1 which is arranged to set a nominal fuel quantity to be supplied to each cylinder at each cycle of the said engine 1.

In a system according to an embodiment of the present invention, the crankshaft speed signal provided by the sensor or detector 4 is acquired and processed in a predetermined manner as represented by a block 7 in FIG. 1, to provide an estimation of the fuel quantity actually injected by each injector. This estimation is processed by a cylinder balancing control block 8 whose output is a fuel quantity correction which is used by the fuel injection control 5 to control the injectors I1-I4, thus compensating (inter alia) the initially discussed effects of drifts and tolerances in the fuel injection system.

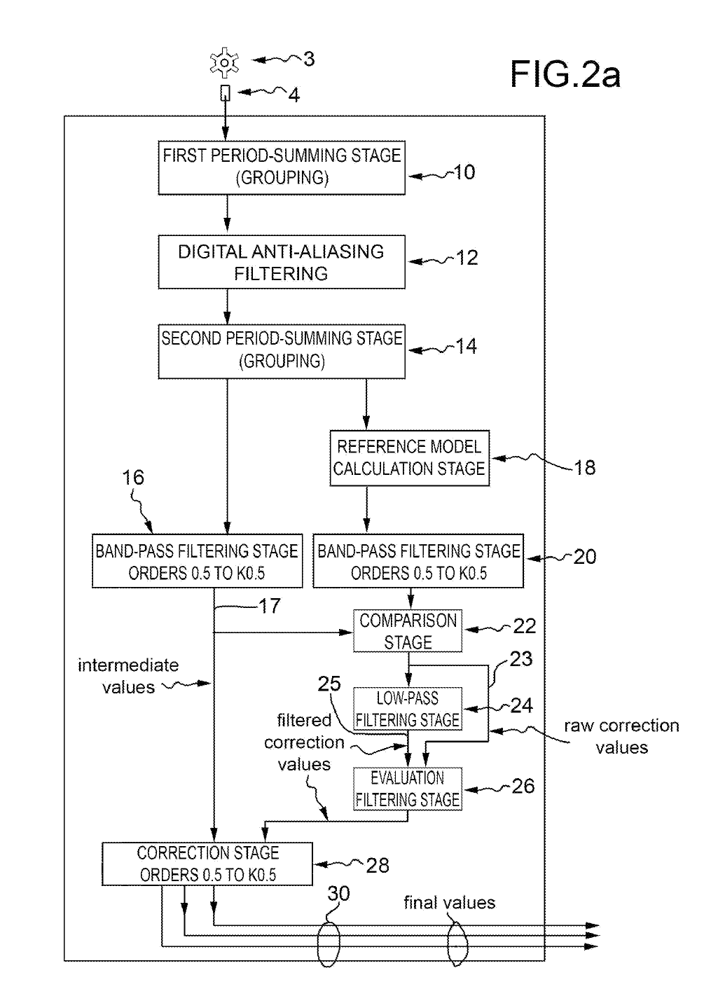

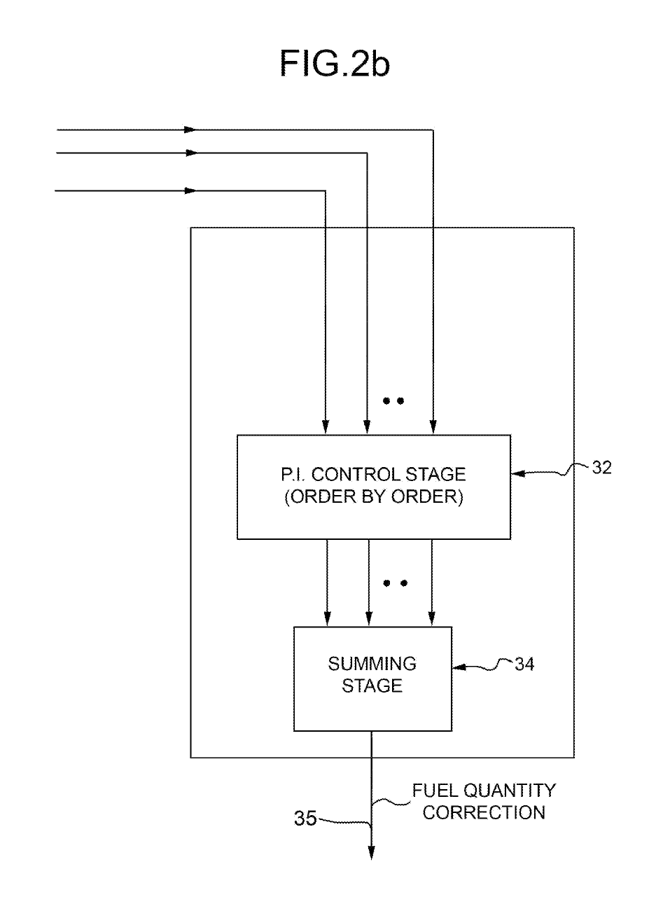

FIG. 2a and FIG. 2b show two portions of a flow chart of the operations performed by the ECU 6 according to the method.

The method of the embodiments of the present invention comprises a first step in which the crankshaft speed signal provided by the sensor 3, 4 is acquired while one predetermined fuel injector is energized for a predetermined period of time in which all the other fuel injectors are not energized. This causes an unbalance to occur, and the effects thereof on the dynamics of the crankshaft wheel 3 are analysed.

The method further includes a step of processing the acquired crankshaft speed signal, so as to obtain signals or data representative of the amplitude of a predetermined harmonic component of said speed signal. In particular, with a 4-stroke internal combustion engine the engine speed component of order 0.5 is the one which has shown the best correlation to the cylinder unbalancing magnitude. This may be explained by taking into account that in the above-first mentioned step of the method only one injector is actually energized during 720° CA.

In that first step of the method, as already mentioned above, an unbalance is caused and in order to detect the magnitude of that unbalance, one can analyze the harmonic components of the engine speed signal provided by means of the crankshaft wheel 3 and the associated detector 4. In particular, the engine speed harmonic components of order 0.5 and multiples of 0.5 are the best suited for the detection of the magnitude of the unbalance.

In general, the analysis of the harmonic components should be focused on the order 0.5, 1.0, 1.5, 2.0, . . . Z/4 where Z is the number of cylinders of the engine.

When all engine cylinders are rather balanced, the amplitudes of these harmonic components are rather small; if the cylinders are not balanced, the amplitudes of the harmonic components become quite large. The amplitudes of the engine speed components of order 0.5 and multiples of 0.5 can be used as a basis for evaluating the magnitude of the unbalance.

With the analysis of 60 tooth periods, the orders that impact are 60. This constraint doesn't allow to easily analyse all 60 teeth because the band pass filter should have the shape shown in FIG. 4. This kind of filter is quite hard to implement in an efficient way because it has a “dead band” too large, therefore it's better to analyze portions (segments) of the crankshaft wheel speed signal. For this reason, the crankshaft wheel speed signal provided by the sensor 4 is subjected, as shown in FIG. 2a, to a first period-summing stage (grouping) 10 so as to obtain portions of said signal. When the tooth time durations are summed each other to obtain these signal portions, the phenomenology of alias occurs because the summing operation is equal to perform data decimations: the highest orders are reflected to lower orders.

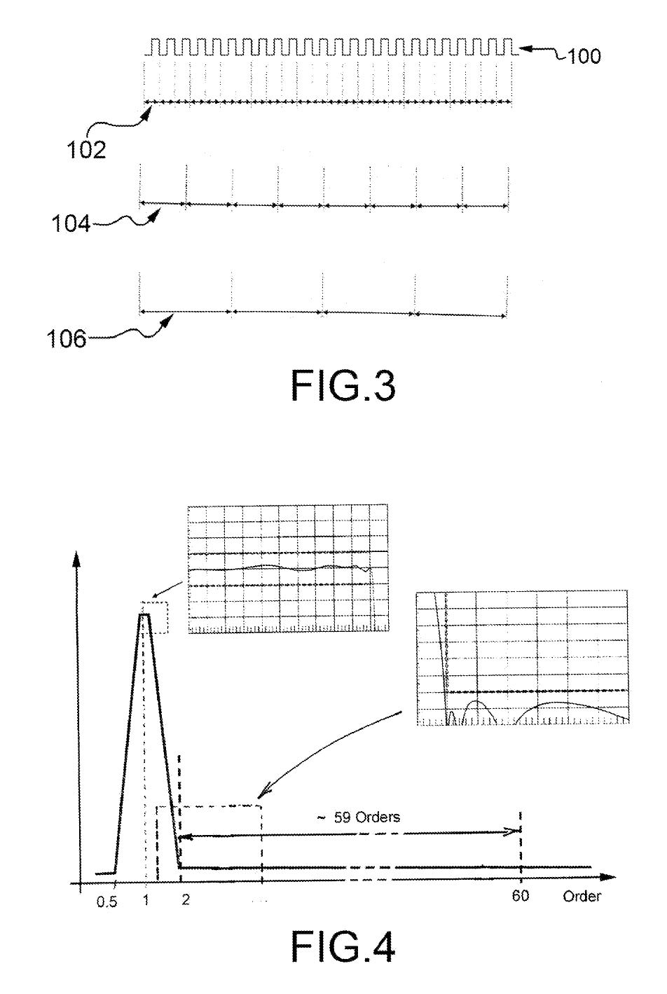

The method comprises therefore a step of performing a digital anti-aliasing filtering 12, particularly applying a FIR filter, and after that a second period-summing stage 14. FIG. 3 shows a schematic representation of a crankshaft wheel signal 100 which is a square wave signal having a predetermined period 102. A predetermined number of adjacent periods (for instance three periods) 102 are summed in the first period-summing stage 10 thus obtaining first signal portions or segments 104 which are in turn summed (for instance in groups of two) in the second period-summing stage 14, so as to obtain second segments 106. The output values of the second period-summing stage 14 are further subjected to a band-pass filtering treatment 16 (FIG. 2a), performed on the harmonic components of order 0.5, 1.0, 1.5, thus obtaining intermediate values 17.

The theory of band-pass filtering can be advantageously applied in order to evaluate the magnitude of the unbalance in the cylinder corresponding to the energized injector. All the calculations in the order domain are performed with a band-pass filter having the following standard difference-equation implementation:

a1y(n)=b1x(n)+ . . . +bnb+1x(n−nb)−a2y(n−1)− . . . −ana+1y(n−na)

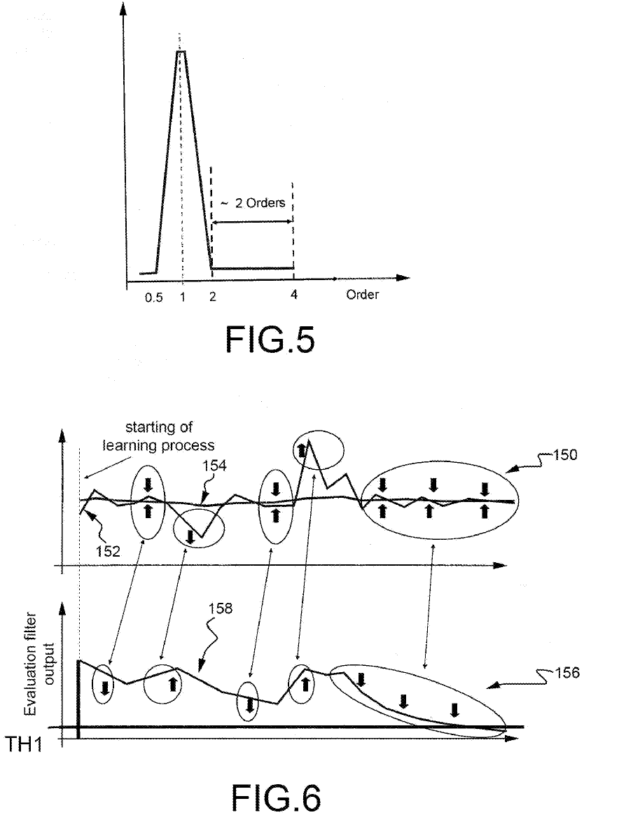

A band-pass filter is a filter which passes frequencies within a certain range and rejects (attenuates) frequencies outside that range. Thanks to the summing stages 10 and 14 it is possible to use a filter having a band-pass characteristic in the frequency or order domain as shown in the qualitative graph of FIG. 5, showing a pass-band around a harmonic component of order 1. The output of a band-pass filter in the time domain is (ideally) a sinusoid.

The output values of the second period-summing stage 14 are further used as input of a reference model calculation stage 18 (see FIG. 1 and FIG. 2a).

In a motor-vehicle the crankshaft wheel speed signal does not only reflect the dynamics of the engine, but is rather also affected by some geometrical-mechanical errors. Thus, a model of ideal crankshaft wheel is needed. In the reference model calculation stage 18, a sum of the segments 106 is performed according to the following equation:

$${Segment}_{model} = \frac{{\sum }_{i = k - j}^{k + z} {Segment}_{i}}{j + z + 1} \qquad ( 1 )$$

Where k is the generic segment 106 for which the model is calculated. This model is free of any geometrical-mechanical errors. The segments model calculated in the reference model calculation stage 18 are then subjected to a band-pass filtering treatment 20, sample by sample, wherein the treatment is performed on the harmonic components of order 0.5, 1.0, 1.5, . . . K0.5.

The intermediate values 17 and the output values of the band-pass filtering treatment 20 are compared in a comparison stage 22 wherein raw correction values 23 are obtained, said raw correction values being calculated as difference, sample by sample, between the intermediate values 17 and the output values of the band-pass filtering treatment 20. The output values of the comparison stage 22 are subjected to a low-pass filtering treatment 24, thus obtaining filtered correction values 25 that are compared with the raw correction values 23 in an evaluation filtering stage 26.

In the evaluation filtering stage 26, an “evaluation filter” is used, said “evaluation filter” being a low-pass filter with an initial value different from zero and arranged to obtain instantaneous difference values calculated as the difference, sample by sample, between the raw correction values 23 and the filtered correction values 25. The “evaluation filter” is then arranged to converge to said difference values.

In FIG. 6 are depicted a first graph 150 showing a first curve 152 representing raw correction values and a second curve 154 representing filtered correction values.

A second graph 156 shows a curve 158 which represents the “evaluation filter” output which tends to the difference between the raw and filtered correction values 23 and 25. When the output values of the “evaluation filter” reach a first predetermined threshold TH1, the procedure is stopped.

Returning now to FIG. 2a, at the end of the evaluation filtering treatment 26, i.e. when the output values of the “evaluation filter” reach the first threshold TH1, the filtered correction values 25 are selected for the next steps.

The filtered correction values 25 are used in a correction stage 28 to correct the intermediate values 17 so as to obtain final values 30, sample by sample, each final value 30 corresponding to the harmonic components of order 0.5, 1.0, 1.5, . . . , K0.5. The final values 30 are obtained as difference between the intermediate values 23 and filtered correction values 25.

Considering the fact that the crankshaft wheel speed signal components with order 0.5 and multiples of 0.5 are linked to the cylinder unbalancing magnitude, a closed loop control can be performed.

The method of the invention comprises therefore a PI control stage 32 in which a proportional and integral control is implemented. The control receives as input the final values 30 from the correction stage 28 and uses a zero unbalance as a reference for the control. The PI control stage 32 operates order by order, and its output values are all summed together in a summing stage 34. The output of the summing stage 34 is a fuel quantity correction 35 which is used by the fuel injection control 5 to control the injectors I1-I4.

Particularly, the fuel quantity correction 35 is added to the nominal fuel quantity requested by the ECU 6 of the engine 1.

The method of the invention operates to cancel the harmonic components of order 0.5, 1.0, 1.5, . . . , K0.5 of the cylinder unbalancing which contribute to the torque unbalancing of the cylinders.

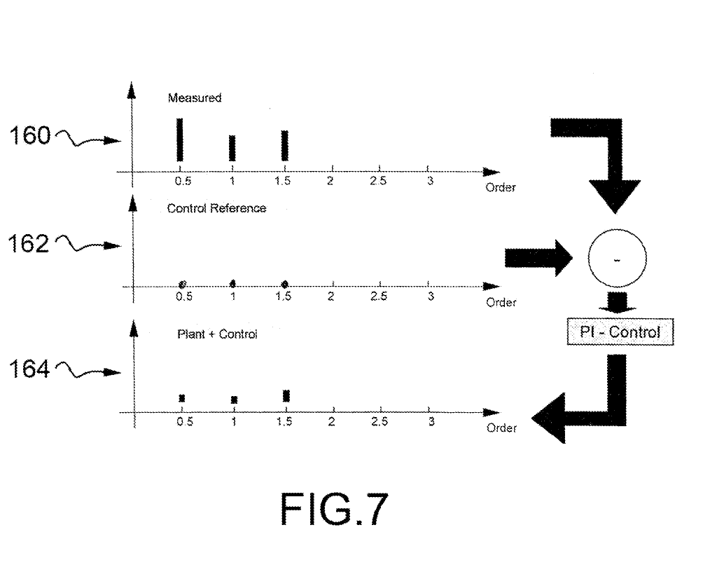

FIG. 7 shows a first graph 160 in which the output values of the correction stage 28 are depicted, a second graph 162 shows the reference of the PI control module, which is zero for all the orders, i.e. an engine perfectly balanced, and a third graph 164 shows the output values of the PI control stage 32.

In the time domain, the effect on the engine is an overlapping of different sinusoids with different periods; the result of all sinusoids will be zero in case of total balance.

Clearly, the principal of the embodiments of the invention remaining the same, the embodiments and the details of production can be varied considerably from what has been described and illustrated purely by way of non-limiting example, without departing from the scope of protection of the present invention as defined by the attached claims. Moreover, while at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A method for a correcting cylinder unbalancing in an internal combustion engine with a plurality of cylinders, and a plurality of electrically controlled fuel injectors for the plurality of cylinders, and with a crankshaft having an associated angular speed detector including a wheel provided with a plurality of substantially equidistant markings having a substantially similar angular width; the method comprising:
acquiring a speed signal while a first fuel injector of the plurality of electronically controller fuel injectors is energized for a determined period in which remaining fuel injectors of the plurality of electrically controlled fuel injectors are de-energized;
generating a square wave signal by scanning said plurality of substantially equidistant markings with a detector, said square wave signal having a predetermined period;
performing a first period-summing to obtain a plurality of first segments of said predetermined period;
performing a digital anti-aliasing filtering of said plurality of first segments;
performing a segment-summing to obtain a second plurality of larger segments;
performing a band-pass filtering on a plurality of predetermined harmonic components to obtain plurality of intermediate values;
creating a plurality of filtered correction values representative of an ideal crankshaft wheel speed signal;
correcting said plurality of intermediate values using said plurality of filtered correction values to obtain a plurality of final values;
performing a proportional and integral control based on said plurality of final values in a component by component manner to produce a plurality of harmonic components;
summing the plurality of harmonic components to obtain a fuel quantity correction value; and
correcting the cylinder unbalancing by controlling the plurality of electrically controlled fuel injectors at least according to said fuel quantity correction value.

2. The method of claim 1, wherein said plurality of harmonic components are components of order 0.5.

3. The method of claim 1, wherein the performing the digital anti-aliasing filtering comprises applying a FIR filter.

4. The method of claim 1, wherein the creating the plurality of filtered correction values comprises summing all second segments according to:
$${Segment}_{model} = \frac{{\sum }_{i = k - j}^{k + z} {Segment}_{i}}{j + z + 1}$$
where k is a segment,
performing the band-pass filtering in a component by component manner to obtain a plurality of comparison values;
comparing the plurality of intermediate values and the plurality of comparison values to obtain a plurality of raw correction values; and
performing a low-pass filtering to obtain said plurality of filtered correction values.

5. The method of claim 4, wherein the plurality of raw correction values are obtained as differences between the plurality of intermediate values and the plurality of comparison values.

6. The method of claim 1, wherein the plurality of final values are calculated as differences in a component by component between the plurality of intermediate values and the plurality of filtered correction values.

7. The method of claim 1, wherein the speed signal is a crankshaft speed signal.

8. The method of claim 1, wherein the speed signal is Wherein the speed signal is an engine speed signal.

9. The method of claim 1, wherein said plurality of harmonic components are components of multiples of 0.5

10. The method of claim 1, wherein said plurality of harmonic components are components of multiples of 0.5 up to Z/4, wherein Z is a number of the plurality of cylinders.
